(19) United States
(12) Patent Application Publication
(10) Pub. No.: US 2024/0105946 A1
(43) Pub. Date: Mar. 28, 2024

(54) HYBRID ELECTRODE DESIGN FOR HIGH ENERGY CELLS

(71) Applicant: Rivian IP Holdings, LLC, Plymouth, MI (US)

(72) Inventors: Byoungchul YOU, Saratoga, CA (US); Cary Michael Hayner, Naperville, IL (US); Soo Kim, Fremont, CA (US); Tae Kyoung Kim, Albany, CA (US); Ki Tae Park, Santa Clara, CA (US); Woochul Shin, Newark, CA (US); Joowook Lee, Palo Alto, CA (US)

(21) Appl. No.: 17/936,333

(22) Filed: Sep. 28, 2022

(51) Int. Cl. H01M 4/62; H01M 4/36; H01M 4/587; H01M 10/0525

(52) U.S. Cl. CPC H01M 4/62; H01M 4/366; H01M 4/587; H01M 10/0525; H01M 2004/027

(57) ABSTRACT

Provided are battery cells comprising: a lithiophilic electrode; and a liquid electrolyte, wherein the battery cell has an N/P ratio of less than 1.0. In some embodiments, the multilayer lithiophilic electrode comprises a first layer comprising predominantly active material and a second layer comprising predominantly lithiophilic material. Other materials used in the first and second layers can include a binder and/or a conducting agent.

### INTRODUCTION

The present disclosure generally relates to electrodes, and more particularly, to hybrid electrodes comprising an active material layer and a lithiophilic layer for high energy cells.

### SUMMARY

Provided herein are hybrid electrodes comprising a layer of predominantly active material and a layer of predominantly lithiophilic material. Also provided are battery cells comprising said hybrid electrode and having an N/P ratio of less than 1.0, rechargeable lithium-ion batteries comprising said hybrid electrode, and electric vehicle systems comprising said hybrid electrode. The hybrid electrodes described herein can increase the energy density of a rechargeable lithium-ion battery, reduce cell cost, improve rate capability, and alleviate safety concerns related to lithium dendrite formation/growth which typically presents in conventional cell designs during fast charging.

Specifically, the hybrid electrodes described in further detail below include a first layer. This first layer can comprise active material. This first layer of active material may directly overlay a current collector. The first layer including an active material may include further components (e.g., binder, conducting agent, lithiophilic material) as well. A second layer is deposited over the first layer and comprises a lithiophilic material. This second layer comprising lithiophilic material may include further components (e.g., active material, binder, conducting agent) as well. In some embodiments, the second layer does not comprise any active material. In some embodiments, the second layer comprises only lithiophilic material.

In some embodiments, the active material of the hybrid electrodes described herein may comprise graphite. However, historically, achieving high electrode loading with graphite (and in particular, with a graphite negative electrode), has been difficult due to a longer lithium diffusion pathway, poor rate capabilities at high C rates, poor kinetics at low temperatures, and poor adhesion due to expansion/contraction (or poor cycle retention).

Other conventional negative electrodes (i.e., anodes) typically used for high energy density also have issues. For example, silicon negative electrodes (theoretical capacity of 3,580 mAh/g, based on Li₁₅Si₄) often exhibit high swelling and higher operational voltage (>0.4V). Another example is lithium negative electrodes (3,862 mAh/g) which often exhibit lithium dendrite formation, poor cycle life, and safety concerns.

The hybrid electrode designs described herein comprising a layer predominantly comprising an active material and a layer predominantly comprising a lithiophilic material can achieve a rechargeable lithium-ion battery with increased energy density while overcoming many of the challenges presented by these conventional electrode designs.

In some embodiments, provided is a battery cell, the battery cell comprising: a lithiophilic electrode; and a liquid electrolyte, wherein the battery cell has an N/P ratio of less than 1.0.

In some embodiments of the battery cell, the lithiophilic electrode is a negative electrode.

In some embodiments of the battery cell, the lithiophilic electrode is a multilayer lithiophilic electrode comprising a first layer comprising an active material.

In some embodiments of the battery cell, the active material is graphite.

In some embodiments of the battery cell, the first layer comprises 0.01 to 50 wt. % binder and 50 to 99.99 wt. % active material.

In some embodiments of the battery cell, the first layer comprises one or more of: 0.01 to 50 wt. % conducting agent or 0.01 to 20 wt. % lithiophilic material.

In some embodiments of the battery cell, the first layer has a loading level (L/L) of 0.1-20 mg/cm2.

In some embodiments of the battery cell, the multilayer lithiophilic electrode is a multilayer lithiophilic electrode comprising a second layer comprising a lithiophilic material.

In some embodiments of the battery cell, the lithiophilic material comprises one or more of carbon, metal, metal alloy, or a polymer.

In some embodiments of the battery cell, wherein the lithiophilic material comprises boron-doped graphene, nitrogen-doped graphene, a metal nanoparticle graphene cage, gold-graphene cage, or a combination thereof.

In some embodiments of the battery cell, the second layer comprises 100 wt. % lithiophilic material.

In some embodiments of the battery cell, the second layer comprises one or more of: 0.01 to 5 wt. % active material, 0.01 to 10 wt. % binder, or 0.01 to 10 wt. % conducting agent, and 75 to 99.99 wt. % lithiophilic material.

In some embodiments of the battery cell, the second layer has a loading level (L/L) of 0.1-10 mg/cm2.

In some embodiments of the battery cell, the lithiophilic electrode comprises a porous N-doped carbon polyhedron core inserted by a lithiophilic material.

In some embodiments of the battery cell, the lithiophilic material comprises metal nanoparticles.

In some embodiments of the battery cell, the N/P ratio is greater than 0.5.

In some embodiments of the battery cell, the lithiophilic electrode is a negative electrode having an areal capacity of 0.01 to 4.99 mAh/cm2.

In some embodiments of the battery cell, the battery cell comprises a positive electrode having an areal capacity of 1.0 to 5 mAh/cm2.

In some embodiments, provided is a rechargeable lithium-ion battery, the rechargeable lithium-ion battery comprising: a battery cell comprising: a lithiophilic electrode; and a liquid electrolyte, wherein the battery cell has an N/P ratio of less than 1.0.

In some embodiments, provided is an electric vehicle system comprising a rechargeable lithium-ion battery comprising: a battery cell comprising: a lithiophilic electrode; and a liquid electrolyte, wherein the battery cell has an N/P ratio of less than 1.0.

The embodiments disclosed above are only examples, and the scope of this disclosure is not limited to them. Particular embodiments may include all, some, or none of the components, elements, features, functions, operations, or steps of the embodiments disclosed above. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE FIGURES

FIG. 1A shows a hybrid electrode design comprising a first layer having an active material and a functional polymer, according to some embodiments;

FIG. 1B shows a hybrid electrode design comprising a first layer having an active material and hollow nanocarbon, according to some embodiments;

FIG. 1C shows a hybrid electrode design comprising a first layer having an active material and carbon nanofiber/nanotubes, according to some embodiments;

FIG. 1D shows a hybrid electrode design comprising a first layer having an active material and graphene oxide or doped graphene, according to some embodiments;

FIG. 2A shows a hybrid electrode design comprising functional polymer in the second layer, according to some embodiments;

FIG. 2B shows a hybrid electrode design comprising hollow nanocarbon in the second layer, according to some embodiments;

FIG. 2C shows a hybrid electrode design comprising carbon nanofiber/nanotubes in the second layer, according to some embodiments;

FIG. 2D shows a hybrid electrode design comprising graphene oxide and/or defected or doped graphene in the second layer, according to some embodiments;

FIG. 3A shows a single layer of active material being deposited on a substrate to form a conventional single-layer electrode, according to some embodiments;

FIG. 3B shows an electrode formed from the single-die deposition method of FIG. 3A, according to some embodiments;

FIG. 3C shows two layers of active material being deposited on a substrate to form a hybrid electrode having two layers, according to some embodiments;

FIG. 3D shows a hybrid electrode formed from the double slot-die deposition method of FIG. 3C, according to some embodiments.

FIG. 4A shows a charge curve and a depiction of a battery cell having conventional, non-hybrid electrodes, according to some embodiments;

FIG. 4B shows a charge curve and a depiction of a battery cell having a hybrid negative electrode, according to some embodiments;

FIG. 4C shows an annotated charge curve and charge operation mechanism of a battery cell having conventional, non-hybrid electrodes, according to some embodiments;

FIG. 4D shows an annotated charge curve and charge operation mechanism of a battery cell having a hybrid negative electrode, according to some embodiments;

FIG. 5 provides a depiction of each electrode design tested in FIGS. 6, 7A, 7B, 8A, and 8B;

FIG. 6 shows relative percentage of anode coating thickness, areal loading, and N/P ratio for the electrode designs shown in FIG. 5;

FIG. 7A shows experimental coin cell voltage profile during a first formation cycle for the electrodes shown in FIG. 5;

FIG. 7B shows a dQ/dV plot during a first formation cycle of the electrodes shown in FIG. 5;

FIG. 8A shows formation cycle comparisons for the electrodes shown in FIG. 5B;

FIG. 8B shows cycle performance for the control and the hybrid electrodes depicted in FIG. 5B;

FIG. 9 illustrates a flow chart for a typical battery cell manufacturing process, according to some embodiments;

FIG. 10 depicts an illustrative example of a cross sectional view of a cylindrical battery cell, according to some embodiments;

FIG. 11 depicts an illustrative example of a cross sectional view of a prismatic battery cell, according to some embodiments;

FIG. 12 depicts an illustrative example of a cross section view of a pouch battery cell, according to some embodiments;

FIG. 13 illustrates cylindrical battery cells being inserted into a frame to form a battery module and pack, according to some embodiments;

FIG. 14 illustrates prismatic battery cells being inserted into a frame to form a battery module and pack, according to some embodiments;

FIG. 15 illustrates pouch battery cells being inserted into a frame to form a battery module and pack, according to some embodiments; and

FIG. 16 illustrates an example of a cross sectional view of an electric vehicle that includes at least one battery pack, according to some embodiments.

### DETAILED DESCRIPTION

Provided herein are hybrid electrodes comprising a first layer and a second layer. The first layer comprises predominantly active material. The second layer comprises predominantly lithiophilic material. This hybrid electrode design can be used in a battery cell with a liquid electrolyte to achieve an N/P ratio of less than 1.0. Also provided within this disclosure are battery cells comprising said hybrid electrode, rechargeable lithium-ion batteries comprising said hybrid electrode, and electric vehicle systems comprising said hybrid electrode.

Electrodes of a battery include active material. Active material reacts chemically during a charge/discharge cycle to produce electrical energy. The hybrid electrodes described herein include an active material component (e.g., graphite), on the anode side. However, they also include a lithiophilic material component. As described herein, the hybrid design of active material combined with a lithiophilic material can achieve a high energy rechargeable battery or battery cell having an N/P ratio of less than 1.0. The lithiophilicity of the electrode may be defined as the capability of a material to form a stable structure with Li, but could be extended to other metal ion batteries as well. For example, in a sodium ion battery, the second layer could be designed for capability to form stable structure with sodium.

As used herein, N/P ratio is defined as a ratio of a maximum capacity per a unit area of an anode active material or a negative electrode (i.e., anode) active material relative to maximum capacity per a unit area of a positive electrode (i.e., cathode) active material at a standard C-rate of 0.1 C. In another embodiment, a slower C-rate such as 0.05 C may be used for materials with reduced ionic conductivities. The N/P ratio can be related the areal capacity of a negative electrode (i.e., anode) relative to a positive electrode (e.g., cathode) of a battery cell. Areal capacity can be measured in units of mAh/cm², and is a measure of the amount of electric charge per unit of surface area of the electrode. The N/P ratio can be defined as the capacity ratio between the electrodes in the battery cell. N/P ratio may also be defined as the amount of coated negative electrode (i.e., anode) active material relative to the amount of coated positive electrode (i.e., cathode) active material.

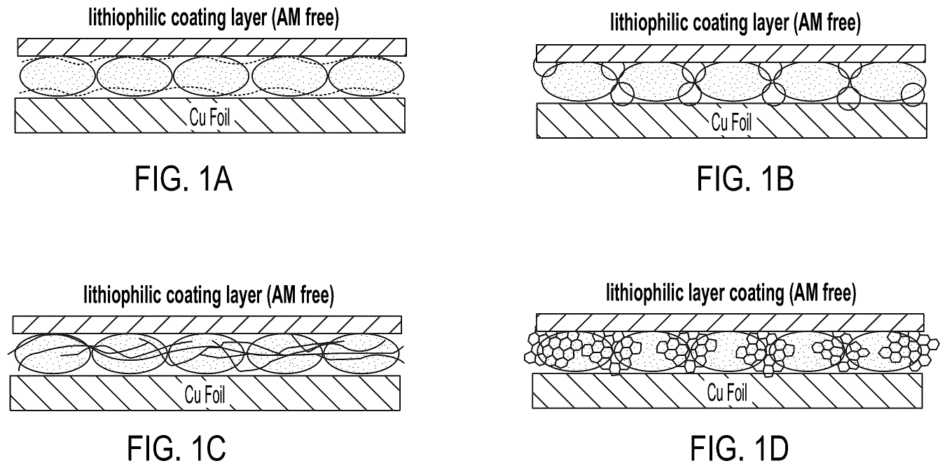

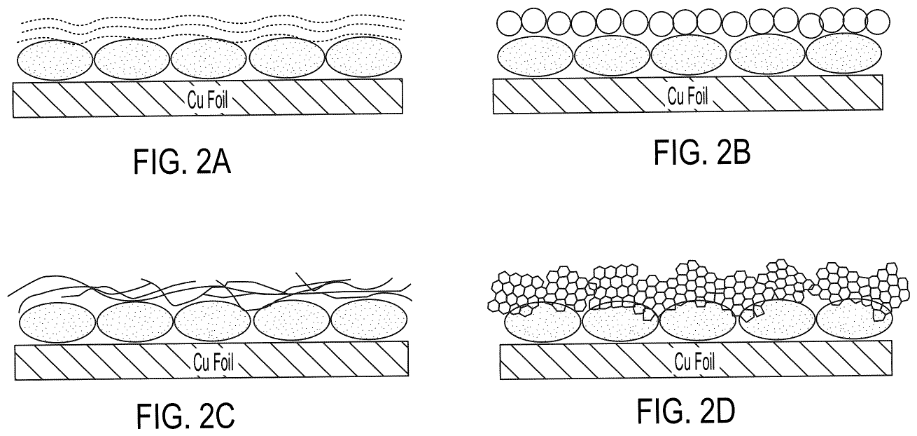

FIGS. 1A-1D show various hybrid electrode designs, according to some embodiments. Specifically, the designs in FIGS. 1A-1D specifically various types of first layer (i.e., active material layer). Each of the designs show a generic lithiophilic coating overlying the first active material layer. The details of this lithiophilic layer will be discussed further below (e.g., with respect to FIGS. 2A-2D). Further, each of the designs in FIGS. 1A-1D show a current collector comprising copper. While copper foil is the most commonly used current collectors on the anode side, other suitable current collector materials that are chemically treated, etched, alloyed, and/or surface-modified may be used, depending on the application, cell chemistry, and cell requirement.

FIG. 1A shows a hybrid electrode design with a first active material layer comprising a functional polymer. For example, the first active material layer of FIG. 1A may comprise graphite anode active materials (AAM), carbon conductive agent (CCA), or styrene-butadiene rubber/carboxymethylcellulose binder with functional polymers such as framework porphyrin, LiPON, PVDF-PAN, and polydopamine (PDA).

FIG. 1B shows a hybrid electrode design with a first active material layer comprising hollow nanocarbon. For example, hollow nanocarbon with materials such as Au-Graphene cage, Ag/N-doped microporous carbon, and PVDF-coated hollow carbon may be used, in addition to conventional anode active materials, carbon conductive agents, and binder materials.

FIG. 2C shows a hybrid electrode design with a first active material layer comprising carbon nanofibers/tubes. For example, carbon nanotubes with 1-25 um length/1-100 nm of multi-walled carbon nanotubes (MWCNT) having defects, Co/MWCNT, Fe/MWCNT ZnO-coated carbon nanotubes, Ag/N-doped carbon microporous fiber, SnS₂/carbon fiber, and Mo₂N/carbon nano fiber can be used, in addition to anode active materials, carbon conductive agents, and binder materials.

FIG. 2D shows a hybrid electrode design with a first active material layer comprising graphene oxide and/or doped graphene. For example, one or more layers of graphene sheets, flake, etc., reduced graphene oxide, graphene oxide with oxygen functional groups such as carbonyl, carboxylic, epoxy, and/or hydroxyl, n- or p-type doped graphene (e.g., nitrogen, boron substituted), graphite, extended graphite, graphitic oxide, Au-Graphene cage, and F₃N/N-doped graphene may be used in addition to conventional anode active materials, carbon conductive agents, and binder materials.

In some embodiments, the first active material layer comprises an active material and a binder. In some embodiments, the first layer can comprise 50-99.99, 60-99, 70-99, 80-99, or 90-99 wt. % active material. In some embodiments, the first layer can comprise less than or equal to 99.99, 99.5, 99, 95, 90, 85, 80, 75, 70, 65, or 60 wt. % active material. In some embodiments, the first layer can comprise greater than or equal to 50, 55, 60, 65, 70, 75, 80, 85, 90, or 95 wt. % active material. Suitable materials for the active material can include functional polymers, hollow nanocarbon, carbon nanofiber, carbon nanotubes, graphene oxide, doped graphene, etc.

In some embodiments, the first active material layer comprises 0.01-50, 0.01-25, or 0.01-10 wt. % binder. In some embodiments, the first layer comprises less than or equal to 50, 40, 30, 20, 15, 10, 5, or 1 wt. % binder. In some embodiments, the first layer comprises greater than or equal to 0.01, 1, 5, 10, 15, 20, 30, or 40 wt. % binder. A first active material layer comprising a higher proportion of binder can improve the adhesion and cycle retention, but also increase the electrode resistance and lower the rate capability. A first active material layer having a lower proportion of binder can increase the energy density (with higher active material) and rate capability, but shorten cycle life with poor adhesion. Suitable materials for the binder can include one or more polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Additional suitable materials for the binder material can include one or more of agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), or xanthan gum.

In some embodiments, the first active material layer can comprise a conducting agent. In some embodiments, the first active material layer does not include a conducting agent. In some embodiments, the first layer can comprise 0.01-50, 0.01-25, or 0.01-10 wt. % conducting agent. In some embodiments, the first layer comprises less than or equal to 50, 25, 20, 15, 10, 5, or 1 wt. % conducting agent. In some embodiments, the first layer can comprise greater than or equal to 0.01, 1, 5, 10, 15, 20, or 25 wt. % conducting agent. A first active material layer comprising a higher amount of conducting agent can increase the electrical conductivity of electrode, improve rate capability, have a large irreversible capacity by consuming electrolyte to form a solid electrolyte interphase layer due to high surface area, and have a high cell cost due to expensive nanocarbon. However, a first active material layer comprising a lower amount of conducting agent may increase cell energy density (with a high amount of active material) and first columbic efficiency, and have poor rate capability.

Suitable conducting agents can include conductive carbon materials such as graphite, carbon black, carbon nanotubes, and the like.

In some embodiments, the first active material layer further comprises a lithiophilic material. In some embodiments, the first active material layer does not comprise a lithiophilic material. In some embodiments, the first layer can comprise 0.01-20, 0.01-10, or 0.01-5 wt. % lithiophilic material. In some embodiments, the first layer can comprise less than or equal to 20, 15, 10, 5, or 1 wt. % lithiophilic material. In some embodiments, the first layer can comprise greater than or equal to 0.01, 1, 5, 10, or 15 wt. % lithiophilic material. A first active material layer with a greater amount of lithiophilic material may increase lithium utilization (avoiding dead lithium or lithium dendrite growth), can improve rate capability due to highly electrical conductivity, may have large irreversible capacity by consuming electrolyte to form a solid electrolyte interphase layer due to high surface area, and may have high cell cost due to expensive materials. A first active material layer comprising a low amount of lithiophilic material may increase first columbic efficiency, and may have a poor cycle life due to continued lithium losses during cycling. Suitable lithiophilic materials can include carbon-type materials, metal or metal alloy materials, or polymeric materials. Examples of carbon-type materials include, but are not limited to, multi-walled carbon nanotubes having defects, boron-doped graphene, nitrogen-doped graphene, a metal nanoparticle graphene cage (e.g., a gold-graphene cage), zinc oxide-coated carbon nanotubes, F₃N/N-doped graphene, Ag/N-doped carbon macroporous fiber, Co/CoₓN/N-doped carbon, MOF-derived ZnO/N-doped carbon sheet, PVDF coated hollow carbon, SnS₂/carbon fiber, Mo₂N/Carbon nanofiber, TiC/C core-shell, and MXene (few-atoms-thick layers of transition metal carbides, nitrides, or carbonitrides). A graphene cage can comprise metallic nanoparticles, for example, gold nanoparticles. Lithium can be preferentially deposited inside the graphene cage at gold nanoparticles. Examples of metal or metal alloy materials include, but are not limited to, silver, gold, copper oxide, bismuth-nanosheet, copper-copper oxide-nickel alloy, copper-lithium oxide alloy, antimony-lithium alloy, aluminum-lithium alloy, zinc-lithium alloy, Li₁₅Au₄, LiZn, manganese-doped Li-LiB, and silver-incorporated metal-organic framework. Examples of polymeric materials include, but are not limited to, framework porphyrin, LiPON, PVDF-PAN, and polydopamine (PDA).

FIGS. 2A-2D show various hybrid electrode designs, according to some embodiments. Specifically, the designs in FIGS. 2A-2D specifically show electrode designs with various types of a second layer (i.e., lithiophilic layer). Each of the designs show a generic first active material layer overlying the current collector and layered underneath the lithiophilic layer. The details of this active material layer are discussed further above (e.g., with respect to FIGS. 1A-1D). Further, each of the designs in FIGS. 2A-2D show a current collector comprising copper. While copper foil is the most commonly used current collectors on the anode side, other suitable current collector materials that are chemically treated, etched, alloyed, and/or surface-modified may be used, depending on the application, cell chemistry, and cell requirement.

Specifically, FIG. 2A shows a second layer comprising a functional polymer. For example, suitable functional polymers may include framework porphyrin, LiPON, PVDF-PAN, and polydopamine (PDA). FIG. 2B shows a second layer comprising hollow nanocarbon. For example, hollow nanocarbon with materials such as Au-Graphene cage, Ag/N-doped microporous carbon, and PVDF-coated hollow carbon may be used, in addition to conventional AAM, CCA, and binder materials. FIG. 2C shows a second layer comprising carbon nanofiber/nanotubes. For example, carbon nanotubes with 1-25 um length/1-100 nm of MWCNT having defects, Co/MWCNT, Fe/MWCNTZnO-coated CNT, Ag/N-doped carbon microporous fiber, SnS₂/carbon fiber, and Mo₂N/carbon nano fiber can be used, in addition to AAM, CCA, and binder materials. FIG. 2D shows a second layer comprising graphene oxide and defected or doped graphene. For example one or more layers of graphene sheets, flake, etc., reduced graphene oxide, graphene oxide with oxygen functional groups such as carbonyl, carboxylic, epoxy, and/or hydroxyl, n- or p-type doped graphene (e.g., nitrogen, boron substituted), graphite, extended graphite, graphitic oxide, Au-Graphene cage, and F₃N/N-doped graphene may be used in addition to conventional AAM, CCA, and binder materials.

In some embodiments, the second (i.e., lithiophilic layer) can comprise 100% lithiophilic material. In some embodiments, the second layer can comprises lithiophilic material in addition to one or more of active material, a binder, or a conducting material.

In some embodiments, the second layer comprises 75-99.99 wt. % lithiophilic material. In some embodiments, the second layer comprises less than or equal to 99.99, 99, 95, 90, 85, or 80 wt. % lithiophilic material. In some embodiments, the second layer comprises greater than or equal to 75, 80, 85, 90, 95, or 99 wt. % lithiophilic material. A second layer comprising a higher proportion of lithiophilic material can improve cell energy density by increasing lithium utilization (and avoiding dead lithium or lithium dendrite growth), can improve rate capability due to highly electrical conductivity and thin first layer coating, may have a large irreversible capacity by consuming electrolyte to form a solid electrolyte interphase layer due to high surface area, and can cause high cell cost due to expensive materials. A second layer with a lower proportion of lithiophilic material can require a thicker first layer to match N/P ratio, may have a lower rate capability due to thick first coating layer, can have medium energy density, and can increase first columbic efficiency by lowering material surface area. Suitable lithiophilic materials can include carbon-type materials, metal or metal alloy materials, or polymeric materials. Examples of carbon-type materials include, but are not limited to, multi-walled carbon nanotubes having defects, boron-doped graphene, nitrogen-doped graphene, a metal nanoparticle graphene cage (e.g., a gold-graphene cage), zinc oxide-coated carbon nanotubes, F₃N/N-doped graphene, Ag/N-doped carbon macroporous fiber, Co/CoₓN/N-doped carbon, MOF-derived ZnO/N-doped carbon sheet, PVDF coated hollow carbon, SnS₂/carbon fiber, Mo₂N/Carbon nanofiber, TiC/C core-shell, and MXene. A graphene cage can comprise metallic nanoparticles, for example, gold nanoparticles. Lithium can be preferentially deposited inside the graphene cage at gold nanoparticles. Examples of metal or metal alloy materials include, but are not limited to, silver, gold, copper oxide, bismuth-nanosheet, copper-copper oxide-nickel alloy, copper-lithium oxide alloy, antimony-lithium alloy, aluminum-lithium alloy, zinc-lithium alloy, Li₁₅Au₄, LiZn, manganese-doped Li-LiB, and silver-incorporated metal-organic framework. Examples of polymeric materials include, but are not limited to, framework porphyrin, LiPON, PVDF-PAN, and polydopamine (PDA).

In some embodiments, the second layer comprises 0.01-5 wt. % active material. In some embodiments, the second layer comprises less than or equal to 5, 4, 3, 2, or 1 wt. % active material. In some embodiments, the second layer comprises greater than or equal to 0.01, 1, 2, 3, or 4 wt. % active material. A second layer having a larger proportion of active material can increase the electrode density (high bulk/tap density of AM) and can contribute small cell capacity in addition to the Li metal. In some embodiments, a specific binder may have interaction with AM to provide good adhesion. A second layer with a lower proportion of active material can utilize more lithium metal deposition which will increase the cell energy a lot. Suitable materials for the active material can include carbon, silicon, silicon oxide, tin, phosphorus, aluminum, antimony, germanium or other metals, binary metal oxides MₓO_{y} (M=Mg, Al, Si, Ti, Mn, Fe, Co, Ni, Cu, Zn, Ge, Zr, Nb, Mo, or Sn, 1<=x<=5, 1<=y<=10). In another embodiment, metal alloys including but not limited to Li—Si, Li—Al, Li—Sb, Li—Sn, Li—P, Li—Ge, Si—Ge, Si—Fe, Si—Al, Si—Co, Si-Ti, or Al—Cu may be suitable for the active material.

In some embodiments, the second layer comprises 0.01-10 wt. % binder. In some embodiments, the second layer comprises less than or equal to 10, 9, 8, 7, 6, 5, 4, 3, 2, or 1 wt. % binder. In some embodiments, the second layer comprises greater than or equal to 0.01, 1, 2, 3, 4, 5, 6, 7, 8, or 9 wt. % binder. A second layer having a higher amount of binder may improve the adhesion and cycle retention by alleviating volume change of lithium metal deposition, but can also increase electrode resistance and lowering rate capability. A second layer having a lower amount of binder can increase the energy density (with higher active material/more lithium deposition sites) and rate capability, but can also shorten cycle life with poor adhesion.

Suitable materials for the binder can include one or more polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Additional suitable materials for the binder material can include one or more of agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA) poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), or xanthan gum.

In some embodiments, the second layer comprises 0.01-10 wt. % conducting agent. In some embodiments, the second layer comprises less than or equal to 10, 9, 8, 7, 6, 5, 4, 3, 2, or 1 wt. % conducting agent. In some embodiments, the second layer comprises greater than or equal to 0.01, 1, 2, 3, 4, 5, 6, 7, 8, or 9 wt. % conducting agent. A second layer having a higher amount of conducting agent may increase electrical conductivity of electrode, improve rate capability, may have a large irreversible capacity by forming large solid electrolyte interphase layers on the high surface area, and can have a high cell cost due to expensive nanocarbon. A second layer having a lower amount of conducting agent may increase cell energy density (high AM amount) and first columbic efficiency. It may also have poor rate capability. Suitable conducting agents can include conductive carbon materials such as graphite, carbon black, carbon nanotubes, and the like.

In some embodiments, as mentioned above, the second lithiophilic layer comprises only lithiophilic material and does not include any active material, binder, or conducting agent. In some embodiments, the second layer comprises all four components: lithiophilic material, active material, binder, and conducting agent. In some embodiments, the second layer comprises lithiophilic material and only one of: active material, binder, and conducting agent. In some embodiments, the second layer comprises lithiophilic material and any two of: active material, binder, and conducting agent.

As described above, battery cells provided herein comprise one or more hybrid electrodes (i.e., an electrode comprising a first active material layer and a second lithiophilic layer) and a liquid electrolyte. These battery cells achieve an N/P ratio of less than 1.0. In some embodiments, the N/P ratio of a battery cell described herein is about 0.01-1.0 or 0.5-1.0. In some embodiments, the N/P ratio of a battery cell described herein is less than or equal to 1.0, 0.9, 0.8, 0.7, 0.6, 0.5, 0.4, 0.3, 0.2, or 0.1. In some embodiments, the N/P ratio of a battery cell described herein is greater than or equal to 0.01, 0.1, 0.2, 0.3, 0.4, 0.5, 0.6, 0.7, 0.8, or 0.9.

In some embodiments, a negative electrode having a hybrid design (i.e., first layer comprising predominantly active material and a second layer comprising predominantly lithiophilic material) may have an areal capacity of 0.01-4.99 mAh/cm². In some embodiments, a negative electrode having a hybrid design as described herein may have an areal capacity of less than or equal to 4.99, 4.5, 4, 3.5, 3, 2.5, 2, 1.5, or 1 mAh/cm². In some embodiments, a negative electrode having a hybrid design as described herein may have an areal capacity greater than or equal to 0.01, 0.5, 1, 1.5, 2, 2.5, 3, 3.5, 4, or 4.5 mAh/cm².

In some embodiments, a battery cell comprising a hybrid negative electrode can include a conventional (i.e., non-hybrid) positive electrode (or cathode). The conventional positive electrode may have an areal capacity of 1.0-5 mAh/cm². In some embodiments, the positive electrode may have an areal capacity of less than or equal to 5, 4.5, 4, 3.5, 3, 2.5, 2, or 1.5 mAh/cm². In some embodiments, the positive electrode may have an areal capacity greater than or equal to 1.0, 1.5, 2, 2.5, 3, 3.5, 4, or 4.5 mAh/cm².

In some embodiments, an anode or a negative electrode having a hybrid design can be paired with a cathode or a positive electrode having a conventional (i.e., non-hybrid) design in a battery cell. Suitable active materials for a positive electrode can include olivine or phosphate-based cathode active materials like lithium iron phosphate, lithium manganese iron phosphate, over-lithiated-oxide material (OLO), nickel-based cathode materials (e.g., Nickel Manganese Cobalt (NMC) like NMC111, NMC523, NMC622, NMC811, NMCA, nickel cobalt aluminum oxide (NCA), and Ni90+), spinel materials such as LiMn₂O₄ and LiNi_{0.5}Mns_{1.5}O₄, conversion materials such as FeF₂, sulfide, etc. and/or combination thereof (i.e., blended cathode materials comprising more than two cathode materials).

Other types of cathode materials that may be used include disordered rocksalt materials (DRX). DRX materials are Li-excess cathode materials which are typically ball-milled very strongly to form a face-centered cubic structure (Li and metal in the A site, and anion in the B site). The A site transition metal includes but not limited to Mn, Ni, Ta, Mo, Ti, Fe, Nb, V, and/or Cr.

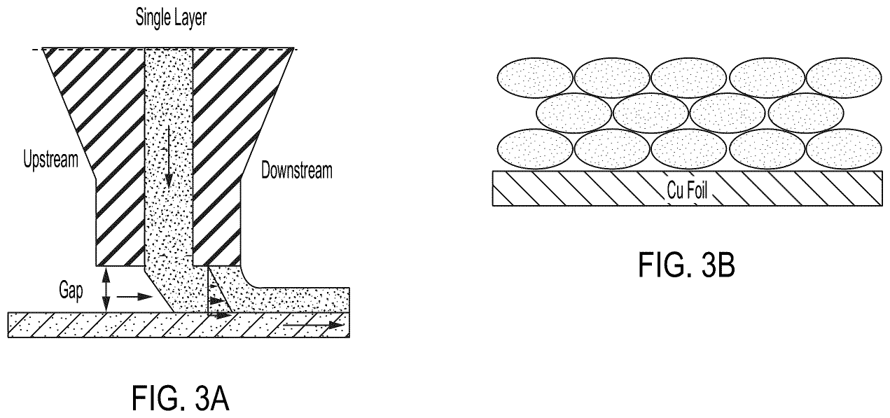

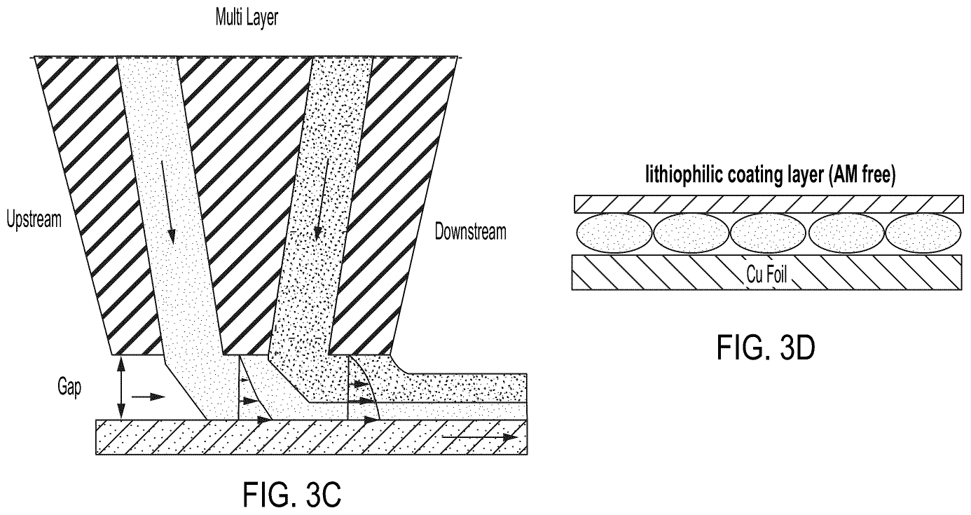

FIG. 3A shows a single layer of active material being deposited on a substrate to form a conventional single-layer electrode. The deposition method includes a single slot-die for depositing a single layer of active material on the substrate or current collector. FIG. 3B shows the electrode formed from the single-die deposition method.

FIG. 3C shows two layers of active material being deposited on a substrate to form a hybrid electrode having two layers, as described herein. This deposition method includes a double slot-die for depositing the first layer and the second layer on a substrate/current collector simultaneously. FIG. 3D shows a hybrid electrode formed from the double slot-die deposition method.

Other methods for manufacturing include, but are not limited to, vapor deposition, 3D printing, sputtering, and hot pressing with lithiophilic free standing film.

In some embodiments, the thickness or loading level (L/L) of a first layer of a hybrid electrode may be 0.1-20 mg/cm². In some embodiments, the loading level of the first layer may be less than or equal to 20, 15, 10, 5, or 1 mg/cm². In some embodiments, the loading level of the first layer may be greater than or equal to 0.1, 1, 5, 10, or 15 mg/cm². In some embodiments, the loading level of the first layer (i.e., active layer) of a hybrid electrode may be less than the loading level of an active layer of a conventional electrode. The thickness of this first active material layer can directly affect the N/P ratio. Thus, the hybrid electrode designs provided herein can achieve a lower N/P ratio (less than 1.0) at least in part because the thickness of the active material layer is thinner than that of conventional electrode designs.

In some embodiments, the thickness or loading level (L/L) of a second layer of a hybrid electrode may be 0.1-10 mg/cm². In some embodiments, the loading level of the second layer may be less than or equal to 10, 8, 6, 4, 2, or 1 mg/cm². In some embodiments, the loading level of the second layer may be greater than or equal to 0.1, 1, 2, 4, 6, or 8 mg/cm².

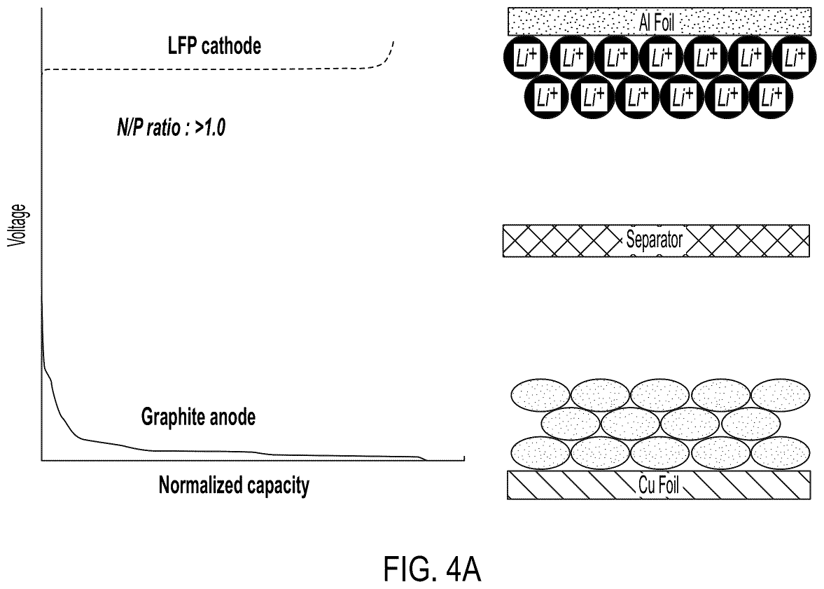

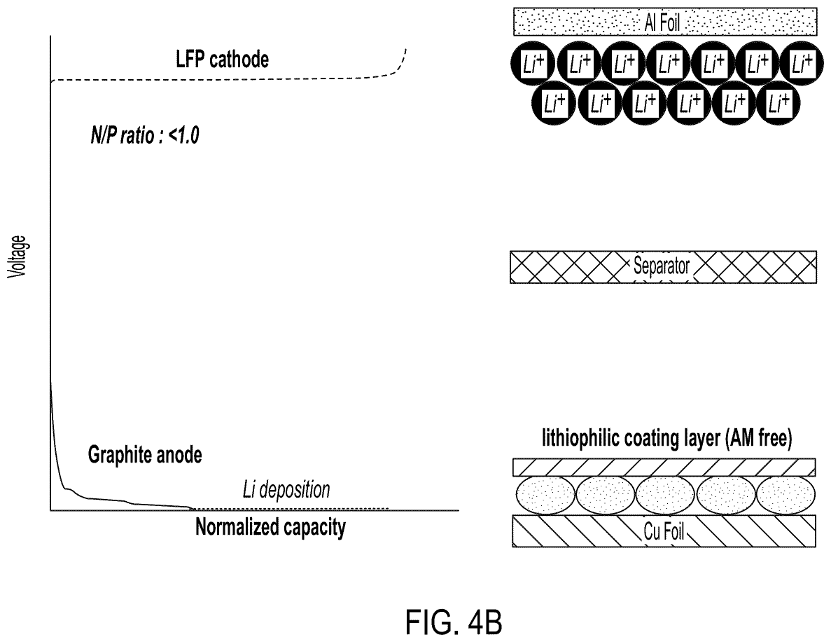

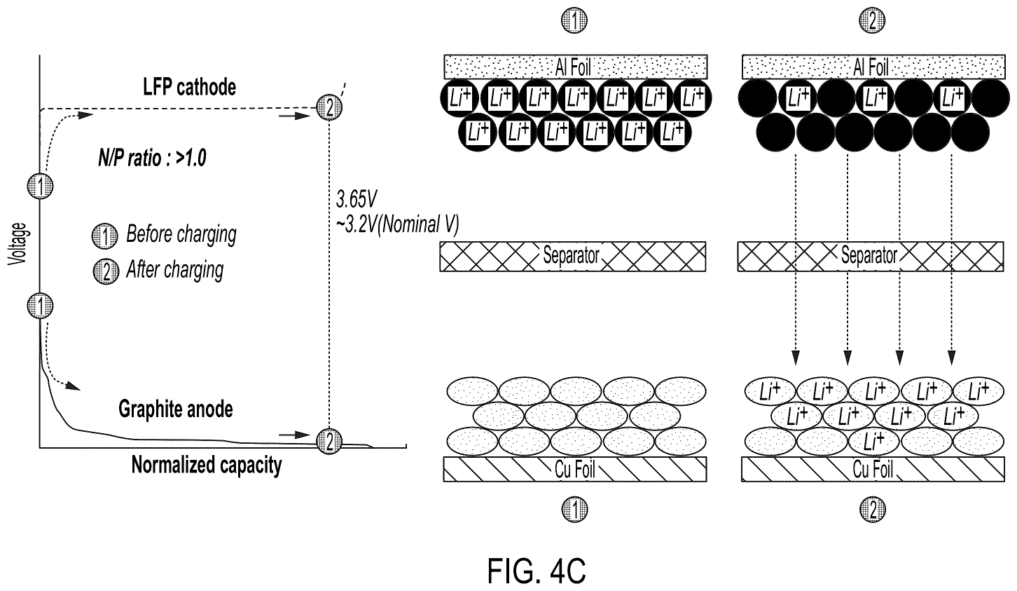

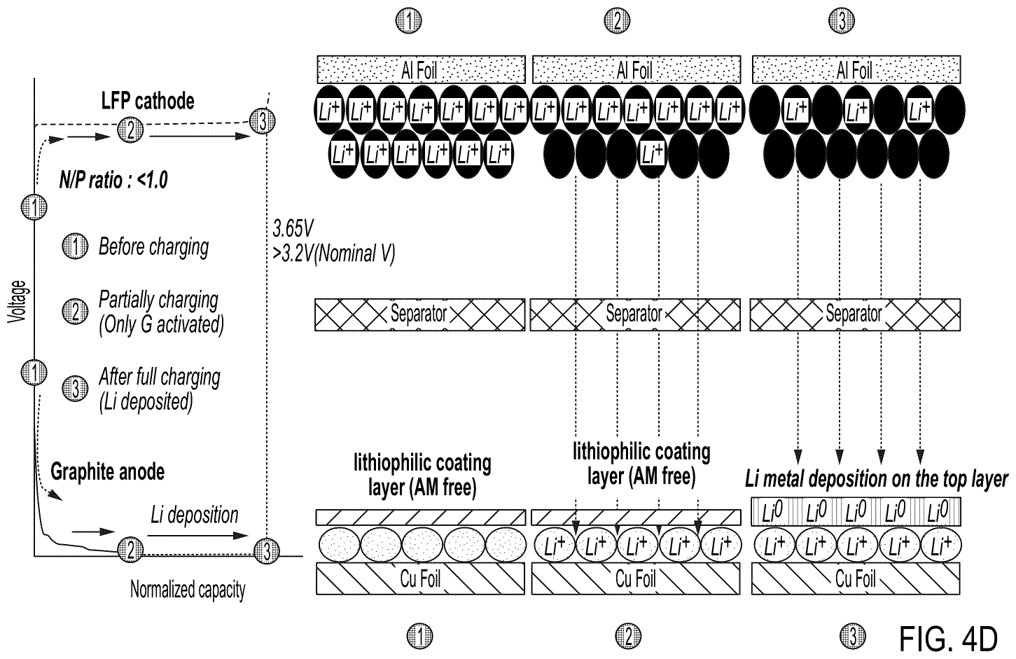

FIG. 4A shows a charge curve and a depiction of a battery cell having conventional, non-hybrid electrodes, and FIG. 4B shows a discharge curve and a depiction of a battery cell having a hybrid negative electrode, according to some embodiments.

FIG. 4C shows an annotated charge curve and a charge operation mechanism of a battery cell having conventional, non-hybrid electrodes, and FIG. 4B shows an annotated charge curve and depiction charge operation mechanism of a battery cell having a hybrid negative electrode, according to some embodiments.

As shown in FIG. 4C, during charging of a battery cell comprising conventional electrodes, the lithium ions migrate from the active material of the positive electrode (top) to the active material of the negative electrode (bottom). However, as shown in a battery cell comprising at least a hybrid negative electrode, as shown in FIG. 4D, the lithium ions migrate from the active material of the positive electrode (top) to the active material of the hybrid negative electrode (bottom). This means that the lithium ions penetrate the lithiophilic (second) layer of the hybrid negative electrode at first, as the active material (first) layer is loaded with lithium ions. Once the active material (first) layer of the hybrid negative electrode is loaded with lithium ions, the remaining lithium ions from the positive electrode are then deposited onto the second (lithiophilic) layer of the hybrid negative electrode.

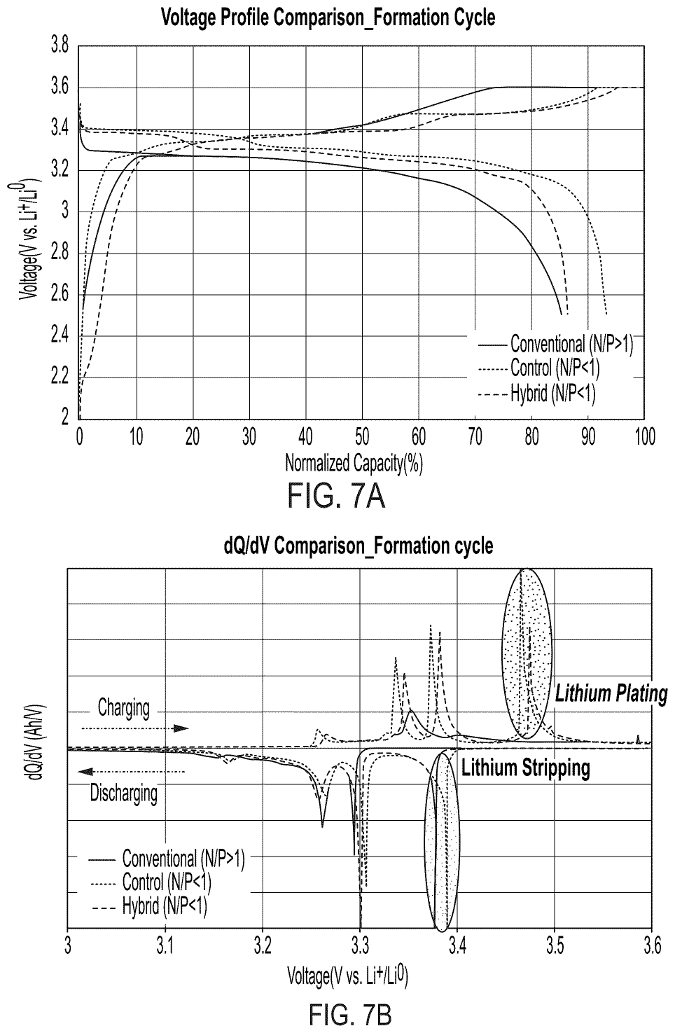

In some embodiments, a cell comprising a lithiophilic negative electrode can exhibit a voltage profile showing high voltage reaction during charge and discharge cycles. In one example, a cell charge and/or discharge cycle can exhibit a greater reaction voltage compared to a cell with a conventional (i.e., non-hybrid) graphite negative electrode. For example, as depicted in FIG. 7A, a hybrid cell with a charge cycle voltage profile can exhibit a plateau above 3.45 V, or between 3.45V and 3.55V. On a discharge cycle, a hybrid cell voltage profile can exhibit a plateau above 3.35 V, or between 3.35V and 3.45V.

### Avoiding Lithium Dendrite Growth in Lithium Metal Battery

When operating under abnormal conditions, (e.g., overcharging, lower temperature charging), a lithium-ion battery can develop lithium dendrite growth or lithium plating. Lithium dendrite growth can cause internal short circuits, leading to battery failure and even safety incidents, such as fire.

Lithium dendrites are metallic microstructures that can form on the negative electrode during the charging process. The dendrites are formed when excess lithium accumulates on the surface of the negative electrode and cannot be absorbed into the negative electrode in a reasonable amount of time.

Currently, methods for minimizing dendrite growth include using a hollow N, O co-doped carbon nanosphere (NOCS) as a current collector for the negative electrode, using boron-doped graphene in the negative electrode, using polyethylene glycol as an electrolyte additive, and using a carbon nanotube sponge as a current collector for the negative electrode.

Further, a hybrid negative electrode as described herein may also help minimize lithium dendrite growth and utilize lithium metal reversibly during cycling to boost energy density in addition to active material capacities in the first layer. Specifically, the presence of the second (lithiophilic) layer can help minimize lithium dendrite growth by providing favorable lithium deposition sites. Not to be bound by any particular theory, but lithium dendrite growth can be mitigated or minimized by providing a lithiophilic layer having homogeneous nucleation sites, a high lithium affinity, a high surface energy and/or a low migration energy. In one example, a homogeneous initial lithiophilic surface composition can be provided to increase the number of dendrite nucleation sites, decreasing lithium dendrite size. In other example, by utilizing the difference of electronegativity between boron atoms and carbon atoms, carbon atoms around boron atoms in boron-doped graphene turn into lithiophilic sites, which can enhance the adsorption capacity to Li+ ions at the nucleation stage. In another example, the porous N-doped carbon polyhedron core inserted by lithiophilic materials (e.g., metal nanoparticles like Cobalt, Boron, Gold, Silver, Antimony, Aluminum, Zinc, Copper oxide, Titanium carbide nanoparticles) provides high specific surface area and enriched nucleation sites to guide smooth lithium nucleation and deposition in the core with decreased nucleation barrier.

### Examples

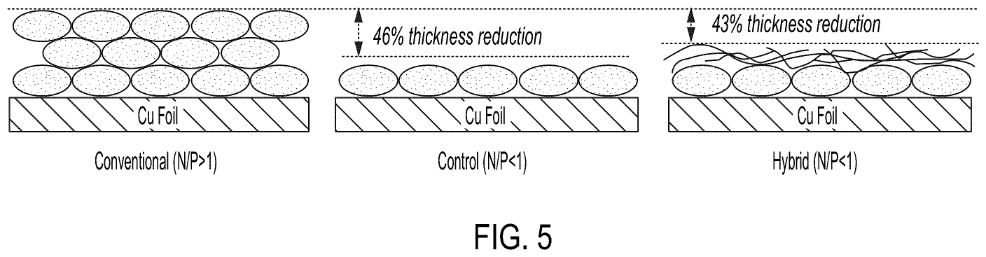

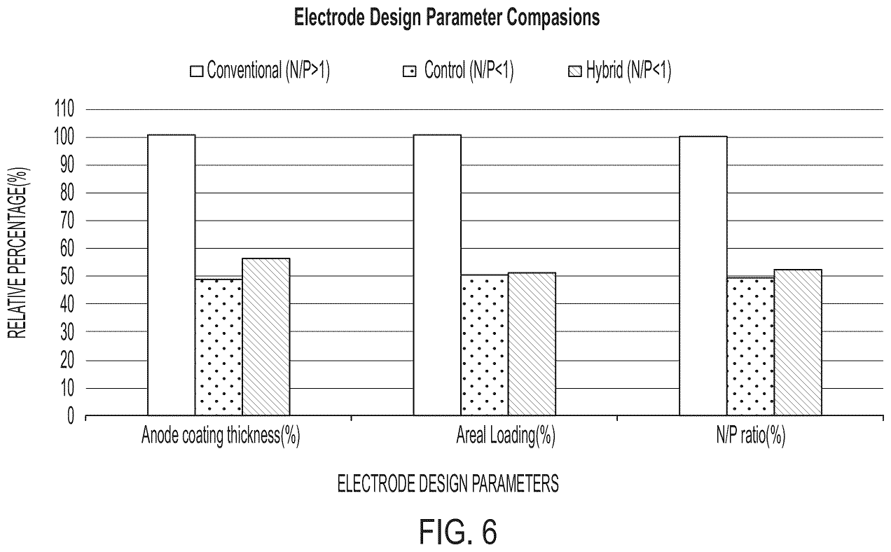

FIG. 5 provides a depiction of each electrode design tested in FIGS. 6, 7A, 7B, 8A, and 8B. Specifically, FIG. 5 shows a depiction of a conventional electrode (with an N/P ratio of greater than 1), a “control” electrode (having an N/P ratio of less than 1), and a hybrid electrode (having an N/P ratio of less than 1). The “control” electrode comprises an active material layer identical to that of the hybrid electrode, but does not include the lithiophilic layer. The hybrid electrode comprises a first active material layer comprising 96.7 wt. % active material, 2.8 wt. % binder, and 0.5 wt. % conducting agent, and a second lithiophilic material layer comprising 80 wt. % lithiophilic material.

The hybrid electrode of FIG. 5 has both a first active material layer and a second lithiophilic material layer. The hybrid electrode depicted in this graph was prepared by dispersing Co/MWCNT in N-methylpyrrolidone solvent and a dispersion agent (e.g., hydrogenated nitrile rubber, polyvinylpyrrolidone, peracetic acid, poly(vinyl alcohol), carboxymethyl cellulose) to form negative electrode slurry. Further N-methylpyrrolidone solvent was added to the slurry to dilute and lower the viscosity of the solution. A negative electrode was formed using a punched coin cell electrode and adding 2-3 drops of the slurry onto the surface of the negative electrode.

FIG. 6 shows relative percentage of anode coating thickness, areal loading, and N/P ratio for the electrode designs shown in FIG. 5. The coating layers of control and hybrid cell were much thinner than one of conventional cell, which can facilitate the Li+ ion diffusion into coated active layer and increase the gravimetric/volumetric cell energy density.

FIG. 7A shows experimental coin cell voltage profile data during a first formation cycle for the electrodes shown in FIG. 5, and the three different cell designs were evaluated as coin full cell format. The conventional design cell showed large voltage polarization and long CV due to the highest anode loading as compared to the others. FIG. 7B shows a dQ/dV plot during a first formation cycle of the electrodes shown in FIG. 5. Unlike conventional cell, the lithium plating/stripping of the control and hybrid cells was observed at the high voltages (>3.45 V vs. Li/Li⁺ in charging step, >3.35 V vs. Li/Li⁺ in discharge step) in dQ/dV plot during 1st formation cycle.

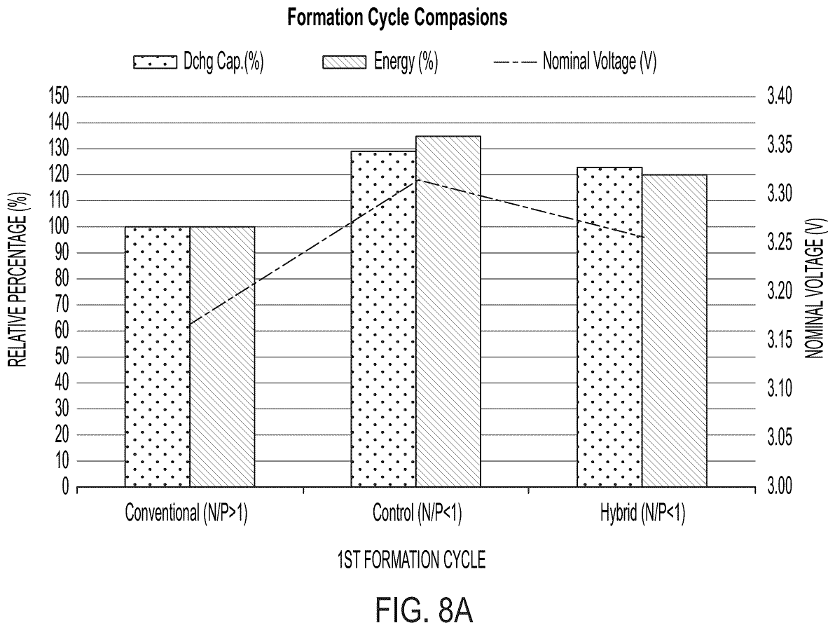

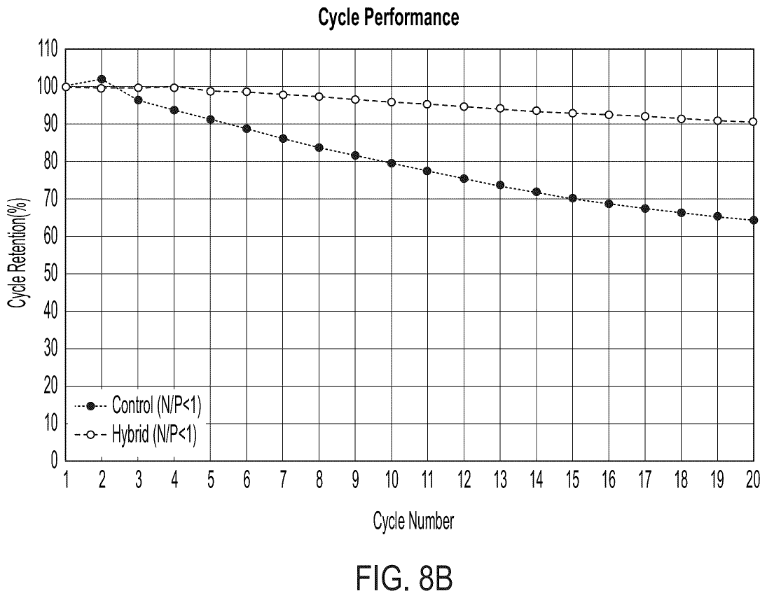

FIG. 8A shows formation cycle comparisons for the electrodes shown in FIG. 5, and FIG. 8B shows cycle performance for the control and the hybrid electrodes depicted in FIG. 5. Experimental results showed higher nominal voltages (>3.25V) and discharge capacity/energy of the control and hybrid cells. The hybrid cell showed better cycle retention as compared to control cell showing that the lithiophilic coating layer can be helpful for lithium metal utilization reversibly during cycling. Energy Density Improvement (N/P=0.1˜0.4) was calculated shown via volumetric energy density (20-40% increase as compared to conventional cell design) and gravimetric energy density (10-20% increase as compared to conventional cell design).

### Battery Cells, Battery Modules, Battery Packs, and Electric Vehicle Systems

The hybrid electrode designs described above can be used in the fabrication of battery cells, rechargeable metal-ion batteries (e.g., lithium, sodium, potassium, aluminum, magnesium), and electric vehicle systems. More specifically, the hybrid electrodes described herein may be used in the fabrication of battery cells that can be used to form battery modules, and/or battery packs. Battery cells, battery modules, and/or battery packs comprising a hybrid electrode described herein may then be used as a power source in electric vehicles. These embodiments are described in detail below.

Reference will now be made to implementations and embodiments of various aspects and variations of battery cells, battery modules, battery packs, and the methods of making such battery cells, battery modules, and battery packs. Although several exemplary variations of the battery cells, modules, packs, and methods of making them are described herein, other variations of the battery cells, modules, packs and methods may include aspects of the battery cells, modules, packs and methods described herein combined in any suitable manner having combinations of all or some of the aspects described. In addition, any part of or any of the electrodes, densified electrodes, components, systems, methods, apparatuses, devices, compositions, etc. described herein can be implemented into the battery cells, battery modules, battery packs, and methods of making these battery cells, battery modules, and battery packs.

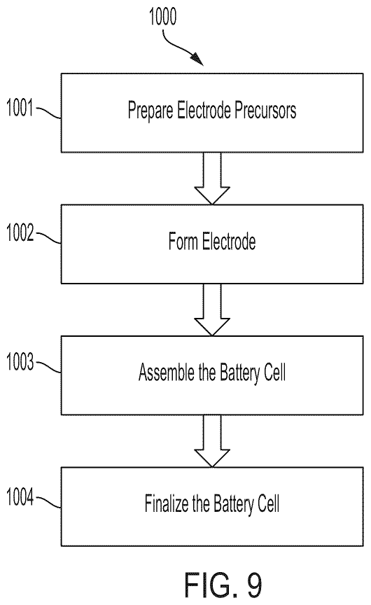

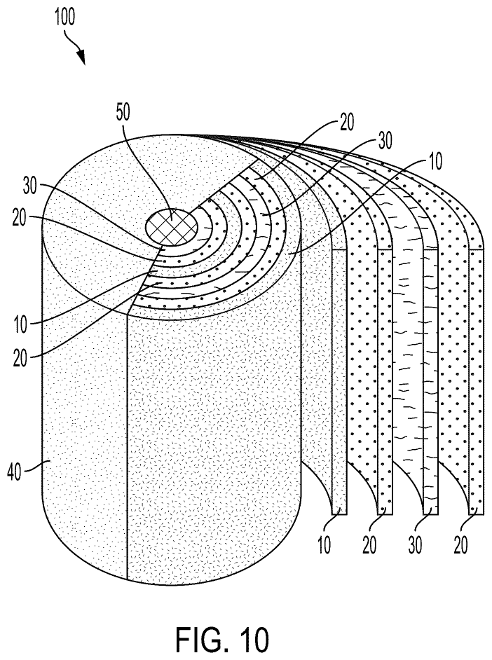

FIG. 9 illustrates a flow chart for a typical battery cell manufacturing process 1000. These steps are not exhaustive and other battery cell manufacturing processes can include additional steps or only a subset of these steps. At step 1001, the electrode precursors (e.g., binder, active material, conductive carbon additive) can be prepared. In some embodiments, this step can include mixing electrode materials (e.g., active materials) with additional components (e.g., binders, solvents, conductive additives, dispersion agents etc.) to form an electrode slurry. Suitable dispersion agents may include hydrogenated nitrile rubber, polyvinylpyrrolidone, peracetic acid, poly(vinyl alcohol), or carboxymethyl cellulose. In some embodiment, this step can include synthesizing the electrode materials themselves.

At step 1002, the electrode can be formed. In some embodiments, this step can include coating an electrode slurry on a current collector. In some embodiments, the electrode or electrode layer can include electrode active materials, conductive carbon material, binders, and/or other additives. In some embodiments, the electrode active materials can include cathode active materials. In some embodiments, the cathode active materials can include high-nickel content (greater than or equal to about 80% Ni) lithium transition metal oxide. Such lithium transition metal oxides can include a particulate lithium nickel manganese cobalt oxide (“LiNMC”), lithium nickel cobalt aluminum oxide (“LiNCA”), lithium nickel manganese cobalt aluminum oxide (“LiNMCA”), lithium cobalt oxide (LCO), lithium manganese oxide (LMO), lithium metal phosphates like lithium iron phosphate (“LFP”), Lithium iron manganese phosphate (“LMFP”), sulfur containing cathode materials, lithium sulfide (Li₂S), lithium polysulfides, titanium disulfide (TiS₂), and combinations thereof.

In some embodiments, the electrode active materials can include anode active materials. In some embodiments, the anode active materials can include graphitic carbon (e.g., ordered or disordered carbon with sp² hybridization, artificial or natural Graphite, or blended), Li metal anode, silicon-based anode (e.g., silicon-based carbon composite anode, silicon metal, oxide, carbide, pre-lithiated), silicon-based carbon composite anode, lithium alloys (e.g., Li—Mg, Li—Al, Li—Ag alloy), lithium titanate, or combinations thereof. In some embodiments, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell may not comprise an anode active material in an uncharged state.

In some embodiments, the conductive carbon material can include graphite, carbon black, carbon nanotubes, Super P carbon black material, Ketjen Black, Acetylene Black, SWCNT, MWCNT, carbon nanofiber, graphene, and combinations thereof. In some embodiments, the binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”), carboxymethylcellulose (“CMC”), agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or combinations thereof.

After coating, the coated current collector can be dried to evaporate any solvent. In some embodiments, this step can include calendaring the coated current collectors. Calendaring can adjust the physical properties (e.g., bonding, conductivity, density, porosity, etc.) of the electrodes. In some embodiments, the electrode can then be sized via a slitting and/or notching machine to cut the electrode into the proper size and/or shape.

In some embodiments, solid electrolyte materials of the solid electrolyte layer can include inorganic solid electrolyte materials such as oxides, sulfides, phosphides, halides, ceramics, solid polymer electrolyte materials, hybrid solid state electrolytes, or glassy electrolyte materials, among others, or in any combinations thereof. In some embodiments, the solid electrolyte layer can include a polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃(A=Ca, Sr, Ba and X=Nb, Ta), lithium phosphorous oxy-nitride (LiₓPO_{y}N_{Z}), among others, or in any combinations thereof. In some embodiments, the solid electrolyte layer can include a glassy, ceramic and/or crystalline electrolyte material such as Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, lithium phosphorous oxy-nitride (LiₓPO_{y}N_{z}), lithium germanium phosphate sulfur (Li₁₀GeP₂S₁₂), Yttria-stabilized Zirconia (YSZ), NASICON (Na₃Zr₂S₁₂PO₁₂), beta-alumina solid electrolyte (BASE), perovskite ceramics (e.g., strontium titanate (SrTiO₃)), Lithium lanthanum zirconium oxide (La₃Li₇O₁₂Zr₂), LiSiCON (Li₂₊₂ₓZn₁₋ₓGeO₄), lithium lanthanum titanate (Li₃ₓLa_{2/3-x}TiO₃) and/or sulfide-based lithium argyrodites with formula Li₆PS₅X (X=Cl, Br) like Li₆PS₅Cl, among others, or in any combinations thereof. Furthermore, solid state polymer electrolyte materials can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), and PEG, among others, or in any combinations thereof.

At step 1003, the battery cell can be assembled. After the electrodes, separators, and/or electrolytes have been prepared, a battery cell can be assembled/prepared. In this step, the separator and/or an electrolyte layer can be assembled between the anode and cathode layers to form the internal structure of a battery cell. These layers can be assembled by a winding method such as a round winding or prismatic/flat winding, a stacking method, or a z-folding method.

The assembled cell structure can then be inserted into a cell housing which is then partially or completed sealed. In addition, the assembled structure can be connected to terminals and/or cell tabs (via a welding process). For battery cells utilizing a liquid electrolyte, the housed cell with the electrode structure inside it can also be filled with electrolyte and subsequently sealed.

Battery cells can have a variety of form factors, shapes, or sizes. For example, battery cells (and their housings/casings) can have a cylindrical, rectangular, square, cubic, flat, or prismatic form factor, among others. There are four main types of battery cells: (1) button or coin cells; (2) cylindrical cells; (3) prismatic cells; and (4) pouch cells. Battery cells can be assembled, for example, by inserting a winding and/or stacked electrode roll (e.g., a jellyroll) into a battery cell casing or housing. In some embodiments, the winded or stacked electrode roll can include the electrolyte material. In some embodiments, the electrolyte material can be inserted in the battery casing or housing separate from the electrode roll. In some embodiments, the electrolyte material includes, but is not limited to, an ionically conductive fluid or other material (e.g., a layer) that can allow the flow of electrical charge (i.e., ion transportation) between the cathode and anode. In some embodiments, the electrolyte material can include a non-aqueous polar solvent (e.g., a carbonate such as ethylene carbonate, propylene carbonate, diethyl carbonate, ethyl methyl carbonate, dimethyl carbonate, or a mixture of any two or more thereof). The electrolytes may also include other additives such as, but not limited to, vinylidene carbonate, fluoroethylene carbonate, ethyl propionate, methyl propionate, methyl acetate, ethyl acetate, or a mixture of any two or more thereof. The lithium salt of the electrolyte may be any of those used in lithium battery construction including, but not limited to, lithium perchlorate, lithium hexafluorophosphate, lithium bis(fluorosulfonyl)imide, lithium bis(trifluorosulfonyl)imide, or a mixture of any two or more thereof. In addition, the salt may be present in the electrolyte from greater than 0 M to about 5 M, or for example salt may be present between about 0.05 to 2 M or about 0.1 to 2 M.

FIG. 10 depicts an illustrative example of a cross sectional view of a cylindrical battery cell 100. The cylindrical battery cell can include layers (e.g., sheet-like layers) of anode layers 10, separator and/or electrolyte layers 20, and cathode layers 30.

A battery cell can include at least one anode layer, which can be disposed within the cavity of the housing/casing. The battery cell can also include at least one cathode layer. The at least one cathode layer can also be disposed within the housing/casing. In some embodiments, when the battery cell is discharging (i.e., providing electric current), the at least one anode layer releases ions (e.g., lithium ions) to the at least one cathode layer generating a flow of electrons from one side to the other. Conversely, in some embodiments, when the battery cell is charging, the at least one cathode layer can release ions and the at least one anode layer can receive these ions.

These layers (cathode, anode, separator/electrolyte layers) can be sandwiched, rolled up, and/or packed into a cavity of a cylinder-shaped casing 40 (e.g., a metal can). The casings/housings can be rigid such as those made from metallic or hard-plastic, for example. In some embodiments, a separator layer (and/or electrolyte layer) 20 can be arranged between an anode layer 10 and a cathode layer 30 to separate the anode layer 20 and the cathode layer 30. In some embodiments, the layers in the battery cell can alternate such that a separator layer (and/or electrolyte layer) separates an anode layer from a cathode layer. In other words, the layers of the battery electrode can be (in order) separator layer, anode/cathode layer, separator layer, opposite of other anode/cathode layer and so on. The separator layer (and/or electrolyte layer) 20 can prevent contact between the anode and cathode layers while facilitating ion (e.g., lithium ions) transport in the cell. The battery cell can also include at least one terminal 50. The at least one terminal can be electrical contacts used to connect a load or charger to a battery cell. For example, the terminal can be made of an electrically conductive material to carry electrical current from the battery cell to an electrical load, such as a component or system of an electric vehicle as discussed further herein.

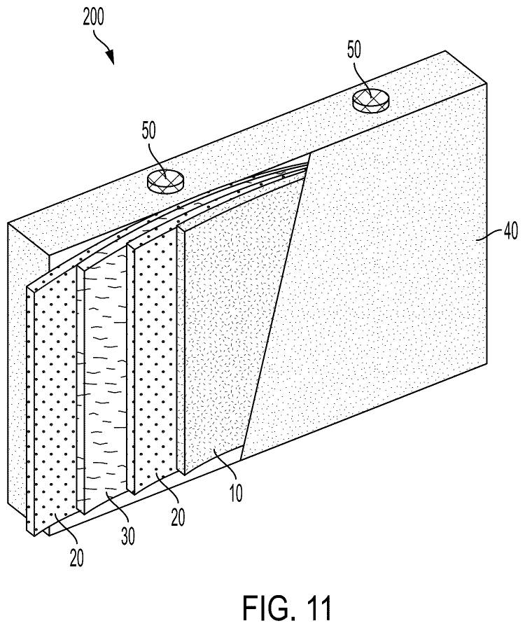

FIG. 11 depicts an illustrative example of a cross sectional view of a prismatic battery cell 200. The prismatic battery cell can include layers (e.g., sheet-like layers) of anode layers 10, separator and/or electrolyte layers 20, and cathode layers 30. Similar to the cylindrical battery cell, the layers of a prismatic battery cell can be sandwiched, rolled, and/or pressed to fit into cubic or rectangular cuboid (e.g., hyperrectangle) shaped casing/housing 40. In some embodiments, the layers can be assembled by layer stacking rather than jelly rolling. In some embodiments, the casing or housing can be rigid such as those made from a metal and/or hard-plastic. In some embodiments, the prismatic battery cell 200 can include more than one terminal 50. In some embodiments, one of these terminals can be the positive terminal and the other a negative terminal. These terminals can be used to connect a load or charger to the battery cell.

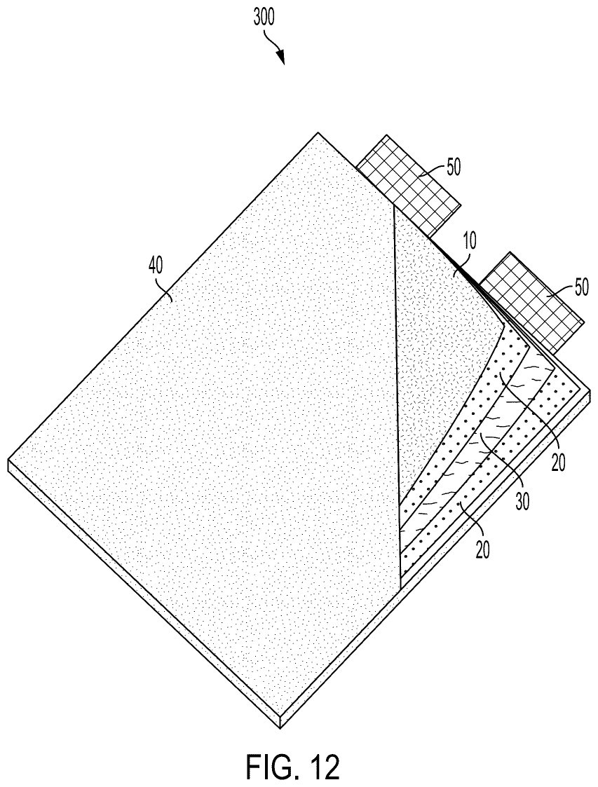

FIG. 12 depicts an illustrative example of a cross section view of a pouch battery cell 300. The pouch battery cells do not have a rigid enclosure and instead use a flexible material for the casing/housing 40. This flexible material can be, for example, a sealed flexible foil. The pouch battery cell can include layers (e.g., sheet-like layers) of anode layers 10, separator and/or electrolyte layers 20, and cathode layers 30. In some embodiments, these layers are stacked in the casing/housing. In some embodiments, the pouch battery cell 200 can include more than one terminal 50. In some embodiments, one of these terminals can be the positive terminal and the other the negative terminal. These terminals can be used to connect a load or charger to the battery cell.

The casings/housings of battery cells can include one or more materials with various electrical conductivity or thermal conductivity, or a combination thereof. In some embodiments, the electrically conductive and thermally conductive material for the casing/housing of the battery cell can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. In some embodiments, the electrically conductive and thermally conductive material for the housing of the battery cell can include a ceramic material (e.g., silicon nitride, silicon carbide, titanium carbide, zirconium dioxide, beryllium oxide, and among others) and/or a thermoplastic material (e.g., polyethylene, polypropylene, polystyrene, polyvinyl chloride, or nylon), among others.

At step 1004, the battery cell can be finalized. In some embodiments, this step includes the formation process wherein the first charging and discharging process for the battery cell takes place. In some embodiments, this initial charge and discharge can form a solid electrolyte interface between the electrolyte and the electrodes. In some embodiments, this step may cause some of the cells to produce gas which can be removed in a degassing process from the battery cell. In some embodiments, this step includes aging the battery cell. Aging can include monitoring cell characteristics and performance over a fixed period of time. In some embodiments, this step can also include testing the cells in an end-of-line (EOL) test rig. The EOL testing can include discharging the battery cells to the shipping state of charge, pulse testing, testing internal resistance measurements, testing OCV, testing for leakage, and/or optically inspecting the battery cells for deficiencies.

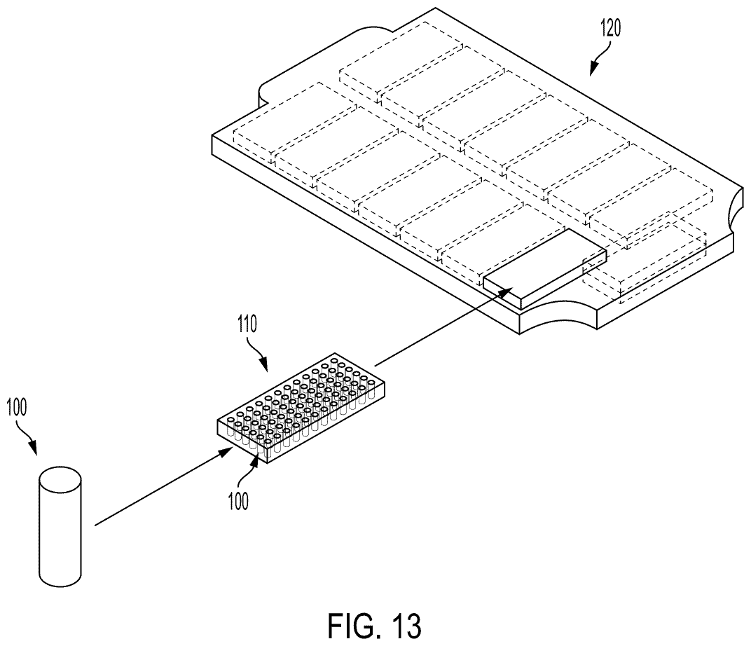

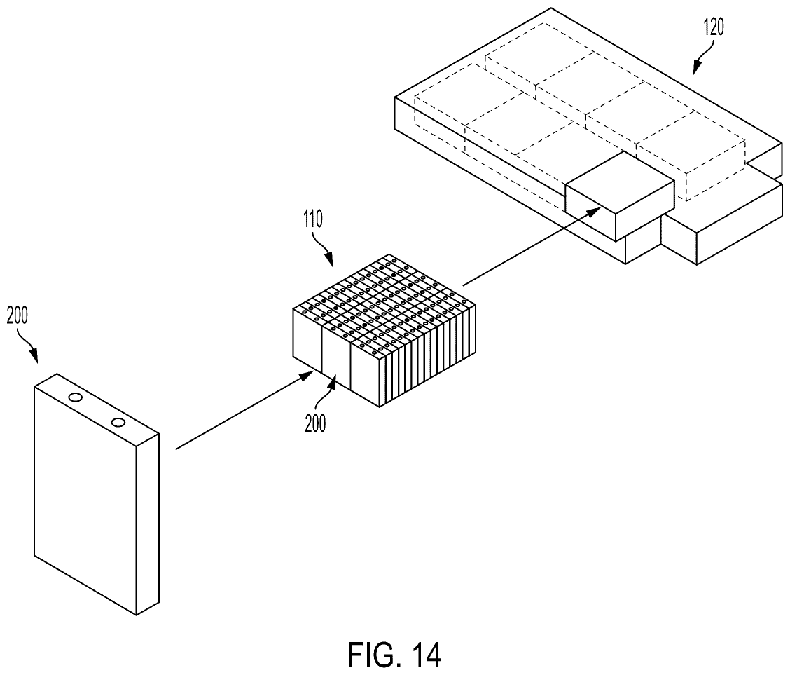

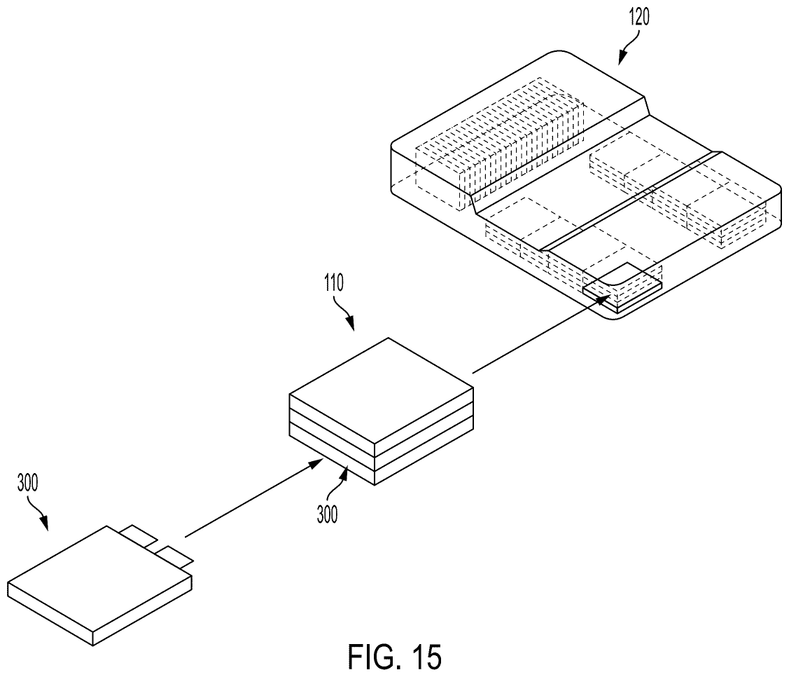

A plurality of battery cells (100, 200, and/or 300) can be assembled or packaged together in the same housing, frame, or casing to form a battery module and/or battery pack. The battery cells of a battery module can be electrically connected to generate an amount of electrical energy. These multiple battery cells can be linked to the outside of the housing, frame, or casing, through a uniform boundary. The battery cells of the battery module can be in parallel, in series, or in a series-parallel combination of battery cells. The housing, frame, or casing can protect the battery cells from a variety of dangers (e.g., external elements, heat, vibration, etc.). FIG. 13 illustrates cylindrical battery cells 100 being inserted into a frame to form battery module 112. FIG. 14 illustrates prismatic battery cells 200 being inserted into a frame to form battery module 112. FIG. 15 illustrates pouch battery cells 300 being inserted into a frame to form battery module 112. In some embodiments, the battery pack may not include modules. For example, the battery pack can have a “module-free” or cell-to-pack configuration wherein battery cells are arranged directly into a battery pack without assembly into a module.

A plurality of the battery modules 112 can be disposed within another housing, frame, or casing to form a battery pack 120 as shown in FIGS. 13-15. In some embodiments, a plurality of battery cells can be assembled, packed, or disposed within a housing, frame, or casing to form a battery pack (not shown). In such embodiments, the battery pack may not include a battery module (e.g., module-free). For example, the battery pack can have a module-free or cell-to-pack configuration where the battery cells can be arranged directly into a battery pack without assembly into a battery module. In some embodiments, the battery cells of the battery pack can be electrically connected to generate an amount of electrical energy to be provided to another system (e.g., an electric vehicle).

The battery modules of a battery pack can be electrically connected to generate an amount of electrical energy to be provided to another system (e.g., an electric vehicle). The battery pack can also include various control and/or protection systems such as a heat exchanger system (e.g., a cooling system) configured to regulate the temperature of the battery pack (and the individual modules and battery cells) and a battery management system configured to control the battery pack's voltage, for example. In some embodiments, a battery pack housing, frame, or casing can include a shield on the bottom or underneath the battery modules to protect the battery modules from external elements. In some embodiments, a battery pack can include at least one heat exchanger (e.g., a cooling line configured to distribute fluid through the battery pack or a cold plate as part of a thermal/temperature control or heat exchange).

In some embodiments, battery modules can collect current or electrical power from the individual battery cells that make up the battery modules and can provide the current or electrical power as output from the battery pack. The battery modules can include any number of battery cells and the battery pack can include any number of battery modules. For example, the battery pack can have one, two, three, four, five, six, seven, eight, nine, ten, eleven, twelve or other number of battery modules disposed in the housing/frame/casing. In some embodiments, a battery module can include multiple submodules. In some embodiments, these submodules may be separated by a heat exchanger configured to regulate or control the temperature of the individual battery module. For example, a battery module can include a top battery submodule and a bottom battery submodule. These submodules can be separated by a heat exchanger such as a cold plate in between the top and bottom battery submodules.

The battery packs can come in all shapes and sizes. For example, FIGS. 13-15 illustrates three differently shaped battery packs 120. As shown in FIGS. 13-15, the battery packs 120 can include or define a plurality of areas, slots, holders, containers, etc. for positioning of the battery modules. The battery modules can come in all shapes and sizes. For example, the battery modules can be square, rectangular, circular, triangular, symmetrical, or asymmetrical. In some examples, battery modules in a single battery pack may be shaped differently. Similarly, the battery module can include or define a plurality of areas, slots, holders, containers, etc. for the plurality of battery cells.

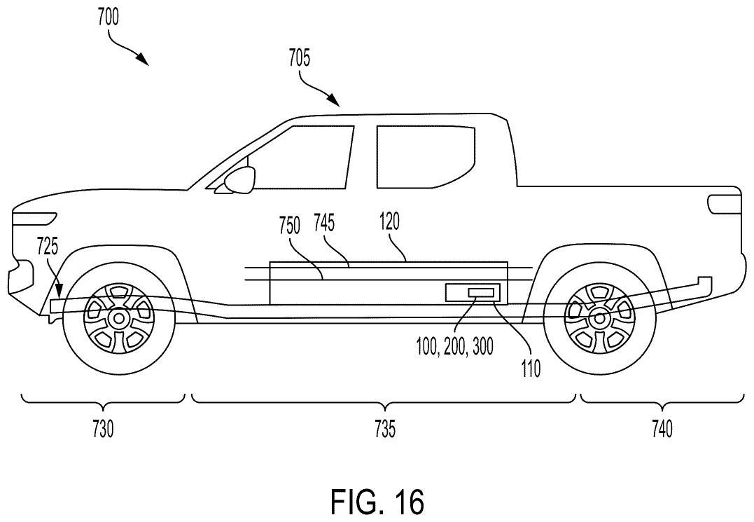

FIG. 16 illustrates an example of a cross sectional view 700 of an electric vehicle 705 that includes at least one battery pack 120. Electric vehicles can include, but are not limited to, electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Electric vehicles can be fully electric or partially electric (e.g., plug-in hybrid) and further, electric vehicles can be fully autonomous, partially autonomous, or unmanned. In addition, electric vehicles can also be human operated or non-autonomous.

Electric vehicles 705 can be installed with a battery pack 120 that includes battery modules 112 with battery cells (100, 200, and/or 300) to power the electric vehicles. The electric vehicle 705 can include a chassis 725 (e.g., a frame, internal frame, or support structure). The chassis 725 can support various components of the electric vehicle 705. In some embodiments, the chassis 725 can span a front portion 730 (e.g., a hood or bonnet portion), a body portion 735, and a rear portion 740 (e.g., a trunk, payload, or boot portion) of the electric vehicle 705. The battery pack 120 can be installed or placed within the electric vehicle 705. For example, the battery pack 120 can be installed on the chassis 725 of the electric vehicle 705 within one or more of the front portion 730, the body portion 735, or the rear portion 740. In some embodiments, the battery pack 120 can include or connect with at least one busbar, e.g., a current collector element. For example, the first busbar 745 and the second busbar 750 can include electrically conductive material to connect or otherwise electrically couple the battery pack 120 (and/or battery modules 112 or the battery cells 100, 200, and/or 300) with other electrical components of the electric vehicle 705 to provide electrical power to various systems or components of the electric vehicle 705. In some embodiments, battery pack 120 can also be used as an energy storage system to power a building, such as a residential home or commercial building instead of or in addition to an electric vehicle.

1: A battery cell comprising:
a lithiophilic electrode comprising:
a first layer comprising an active material, wherein the first layer comprises one or more of: 0.01 wt. % to 50 wt. % of a conducting agent or 0.01 wt. % to 20 wt. % of a lithiophilic material; and
a second layer, and
a liquid electrolyte, wherein the battery cell has an N/P ratio of less than 1 and the N/P ratio is a capacity ratio of a negative electrode areal capacity over a positive electrode areal capacity in the battery cell.

2: The battery cell of claim 1, wherein the lithiophilic electrode is a negative electrode.

3. (canceled)

4: The battery cell of claim 1, wherein the active material is graphite.

5: The battery cell of claim 1, wherein the first layer comprises 0.01 wt. % to 50 wt. % of a binder and 50 wt. % to 99.99 wt. % of the active material.

6. (canceled)

7: The battery cell of claim 1, wherein the first layer has a loading level (L/L) of 0.1-20 mg/cm².

8: The battery cell of claim 1, wherein the multilayer lithiophilic electrode is a multilayer lithiophilic electrode comprising a second layer comprising a lithiophilic material.

9: The battery cell of claim 8, wherein the lithiophilic material comprises one or more of carbon, metal, metal alloy, or a polymer.

10: The battery cell of claim 8, wherein the lithiophilic material comprises boron-doped graphene, nitrogen-doped graphene, a metal nanoparticle graphene cage, gold-graphene cage, or a combination thereof.

11: The battery cell of claim 8, wherein the second layer comprises 100 wt. % of the lithiophilic material.

12: The battery cell of claim 8, wherein the second layer comprises 0.01 wt. % to 5 wt. % of an active material, 0.01 wt. % to 10 wt. % of a binder, 0.01 wt. % to 10 wt. % of a conducting agent, 75 wt. % to 99.99 wt. % of the lithiophilic material, or any combination thereof.

13: The battery cell of claim 8, wherein the second layer has a loading level (L/L) of 0.1-10 mg/cm².

14: The battery cell of claim 1, wherein the lithiophilic electrode comprises a porous N-doped carbon polyhedron core inserted by a lithiophilic material.

15: The battery cell of claim 14, wherein the lithiophilic material comprises metal nanoparticles.

16: The battery cell of claim 1, wherein the N/P ratio is greater than 0.5.

17: The battery cell of claim 1, wherein the lithiophilic electrode is a negative electrode having an areal capacity of 0.01 mAh/cm² to 4.99 mAh/cm².

18: The battery cell of claim 1, comprising a positive electrode having an areal capacity of 1.0 mAh/cm² to 5 mAh/cm².

19: A rechargeable lithium-ion battery comprising:
a battery cell comprising:
a lithiophilic electrode comprising:
a first layer comprising an active material, wherein the first layer comprises one or more of: 0.01 wt. % to 50 wt. % of a conducting agent or 0.01 wt. % to 20 wt. % of a lithiophilic material; and
a second laver; and
a liquid electrolyte, wherein the battery cell has an N/P ratio of less than 1.0 and the N/P ratio is a capacity ratio of a negative electrode areal capacity over a positive electrode areal capacity in the battery cell.

20: An electric vehicle system comprising the rechargeable lithium-ion battery of claim 19.
